(19) United States
(12) Patent Application Publication
(10) Pub. No.: US 2008/0185556 A1
(43) Pub. Date: Aug. 7, 2008

(54) Oxygen generating composition

(76) Inventor: Matthew J. Noble, Lancaster, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/011,570

(22) Filed: Jan. 28, 2008

Related U.S. Application Data
(60) Provisional application No. 60/897,644, filed on Jan. 26, 2007.

(51) Int. Cl. C01B 13/08

(52) U.S. Cl. 252/186.24

(57) ABSTRACT

Provided is an oxygen generating composition comprising a metal powder fuel, a transition metal oxide catalyst, a reaction moderator, a binder, an additive, and an oxygen source. The additives are feldspar or anhydrous aluminum silicate, or both. The oxygen generating composition can be used to generate oxygen on thermal decomposition. The oxygen generating composition is suitable for incorporation into oxygen generating candles. Oxygen generating candles of the present invention have the advantages of lower chlorine concentration, better reaction rate control, and lesser sensitivity to temperature effects on oxygen generation when compared with conventional oxygen generating candles. Additionally, oxygen generating candles comprising the compositions of the present invention can result in candles that do not contain barium compounds, and are non-hazardous, stable to moisture, CO₂, and to air, and are suitable for either wet or dry processing methods.

This application claims priority to U.S. provisional application No. 60/897,644 filed Jan. 26, 2007, the disclosure of which is incorporated herein by reference.

### FIELD OF THE INVENTION

The present invention is related to oxygen generating composition and more particularly to oxygen generating compositions comprising feldspar or anhydrous aluminum silicate, or both.

### BACKGROUND OF THE INVENTION

Chemical oxygen candles based on the decomposition of alkali metal chlorates or perchlorates are used where an oxygen supply is needed in passenger aircraft, submarines, space capsules, and other closed atmospheric conditions. In such applications oxygen output or flow rate from an oxygen candle is typically determined by: 1) the chemical composition of the candle; 2) the physical characteristics of the chemical constituents; 3) one or more sustaining mix layers; and 4) the diameter of the candle. All four of these are intimately linked when designing an oxygen candle to produce a specific oxygen output for a pre-determined time.

First, in regard to chemical composition, the metal powder fuel and metal oxide catalyst directly speed up (as their quantity in the mix increases) or slow down (as their quantity in the mix decreases) the decomposition reactions. Similarly, the more oxygen source material (i.e., chlorate salt) there is in a candle of fixed size, the greater the amount of oxygen that can be produced. Conversely, the less oxygen source material (i.e., chlorate salt) there is, the smaller the amount of oxygen that can be produced. Also, the greater the amount of inert inorganic binder (e.g., mica and amorphous silicon dioxide) there is in a candle of fixed size, the smaller the amount of oxygen that is produced. Moreover, when inert inorganic refractory materials, such as those previously described, are used in oxygen candles fixed in size, their inclusion usually means that something has to be removed from the candle in order to include them. The constituent that is usually displaced is the chlorate or perchlorate oxygen source. Additionally, when discussing the concentration of chemical constituents in a candle of fixed size, the percentage for a given chemical constituent is generally described as the weight percentage of the chemical, unless otherwise specified.

Second, the physical characteristics of the chemical constituents have a significant impact on the oxygen output or flow rate. Two of the most significant are surface area and particle size. It has been demonstrated in the literature that as surface area for reactants increases for a candle of fixed size, so does the oxygen production rate. Likewise, as the surface area of reactants decreases so too does the oxygen production rate. In regards to particle size, the minimum quantity of a reactant is usually limited by its particle size with regard to being able to be well distributed in a given mixture of chemicals. The smaller the size, the easier it is to get the particles more uniformly distributed in a mix. Thus, smaller sized particles preferred are recommended for smoothly performing candles.

Third, one or multiple sustaining mix layers are typically used to meet oxygen output or flow rates required by a fixed size oxygen candle. Different sustaining mix layers are usually differentiated by differences in the weight percentages of mix components and/or the use and/or exclusion of chemical constituents in the sustaining mix layer. A sustaining mix layer is herein defined as a uniform mixture of chemical constituents in a fixed-size chemical core that produces a given quantity of oxygen for a given amount of time.

Fourth, all other things being equal, oxygen output or flow rate is directly proportional to candle diameter—the greater the candle diameter, the greater the oxygen output. Candles with too small a diameter tend to be fragile and can possibly break or fracture under load or when exposed to aircraft vibrations. Additionally, an oxygen candle may have a maximum diameter to fit within a housing package that in turn is required to fit within an envelope where the unit is stored as an emergency oxygen supply device. In other words, the diameter of an oxygen candle is usually limited by the envelope/package that the candle must fit into.

Oxygen generating candles are required to operate and comply with oxygen flow requirements at specified minimum and maximum temperatures. At hot temperature extremes oxygen candles tend to evolve oxygen at faster rates and therefore for shorter durations. Conversely, at cold temperature extremes oxygen candles tend to evolve oxygen at slower rates and therefore for longer durations. Furthermore, it is well understood that oxygen candle formulations that use a catalyst as the primary reactant are significantly more sensitive to temperature extremes, and candles not relying on a catalyst are not practical due to the higher temperatures produced by the un-catalyzed reaction. Oxygen candles that are more sensitive to temperature must therefore be designed to have higher oxygen flow rates and for longer durations than the minimum required flow rate and duration at normal temperatures in order to meet the requirements when operated at high and low temperature conditions. As a result, oxygen generating candles that are more sensitive to temperature extremes will be larger in size and weight than candles that are less sensitive to temperature extremes.

Previous oxygen candles have included an alkali metal chlorate or perchlorate as the source of oxygen which is produced upon thermal decomposition. Iron or other metal powders are typically added as a fuel to furnish the extra heat necessary to help sustain the decomposition reaction. A metal oxide catalyst (e.g., a transition metal oxide catalyst) is commonly used to facilitate decomposition. Inert ceramic oxides such as glass powders or glass fibers are used as binders, or reaction moderators. Reaction moderators are typically used to modify decomposition rates or promote uniform oxygen generation, or both. Barium peroxide, BaO, an alkali earth metal oxide, has been used in oxygen candles to smooth decomposition and suppress toxic free chlorine gas formation. Although BaO has been used in oxygen candles for decades, it is known to be a hazardous chemical. Furthermore, environmental regulations require costly special disposal of candle manufacturing waste.

The use of alkali and alkali-earth metal oxides, other than those containing barium, as reaction moderators that promote more uniform oxygen evolution and suppress chlorine gas formation in oxygen candles is well known. However, there are a number of inherent characteristics of the alkali and alkali-earth metal oxides that make them more difficult to incorporate into oxygen candles. In particular, these compounds are hygroscopic, readily absorb CO₂ from the air, are very caustic, or have a combination of these properties. In fact, a number of these oxides decompose or react violently, including exploding, or both, when brought into contact with water. These characteristics create handling, production, and storage problems. For example, candles incorporating such compounds must be produced by a water-free process and in extremely controlled and dry manufacturing environments. As a result, candles incorporating such compounds cannot be manufactured by wet processing methods. Additionally, such candles may require costly special disposal methods when expended or scrapped because of possible remaining caustic and/or very reactive alkali/alkali-earth metal oxides.

Certain inert inorganic refractory materials, including glass, amorphous silica (SiO₂), alumina (Al₂O₃), and titanium dioxide (TiO₂), in their various forms (powder, fibers, fumed) have been used in chlorate and perchlorate candles to control chlorate and perchlorate decomposition reaction rates, to smooth out oxygen evolution from the decomposing candle, as binders that help hold the chemical constituents together before and after decomposition, and to help in the mixing of chemical constituents and the forming of the candle. Although, as noted above, the use of inorganic refractory materials may provide a number of benefits, their incorporation into the oxygen candle generally means another component must be displaced or taken out of the candle. The component that is usually displaced is the chlorate or perchlorate oxygen source, which in turn leaves a reduced oxygen capacity or a larger and heavier candle to meet oxygen supply requirements.

Based on the foregoing, there is an ongoing need to develop oxygen generating formulations which have low chlorine gas formation, reduced incorporation of inorganic refractory materials as additives, and are less sensitive to temperature effects.

### SUMMARY OF THE INVENTION

The present invention provides oxygen generating compositions suitable for use in oxygen generating candles. The compositions may comprise a metal fuel, a transition metal oxide catalyst, a reaction rate moderator, a binder, an O₂ source, and an additive selected from feldspar, anhydrous aluminum silicate (AAS), or combinations thereof. Oxygen generating compositions comprising feldspar as an additive have the advantages of lower chlorine gas formation. Oxygen generating compositions comprising anhydrous aluminum silicate as an additive have the advantage of improved reaction rate control versus equal amounts of other similar inert inorganic additives. Additionally, oxygen generating compositions comprising iron metal powder, sodium chlorate, inert additive binders, feldspar, and anhydrous aluminum silicate have the advantage of lesser sensitivity to temperature effects on oxygen generation than existing compositions, such as those based on barium compounds.

Oxygen generating candles comprising the compositions of the present invention can result in candles that do not contain barium compounds, and are non-hazardous, stable to moisture, CO₂, and to air, and have an increased amount of oxygen source in the candle relative to the same volume of previously available formulations. Furthermore, such candles are suitable for either wet or dry processing methods. Candles comprising the compositions of the present invention are more easily handled than previously available candles, and can be produced in environments which are not required to be water free and rigorously environmentally controlled. Additionally, alkali metal chlorate and perchlorate candles incorporating these compositions described herein can function effectively across a wide range of environmental temperatures.

As a result of restrictions in candle composition and size restrictions it is an object of the invention to maximize or optimize candle formulations, or both, with as much oxygen source material as possible when designing a candle for a specific oxygen output. In this regard, we have determined that an oxygen candle incorporating the composition of the present invention uses less anhydrous aluminum silicate in its formulation than the total amount of other typical inorganic refractory materials (such as SiO₂, Al₂O₃, TiO₂) that is required to achieve similar oxygen outputs in other known formulations. As a consequence of using less inert inorganic refractory material in the candle formulation, more chlorate or perchlorate oxygen source material is available for candles fixed in size. Likewise, in lieu of using more chlorate or perchlorate for oxygen, the size and weight of the oxygen candle may be reduced while still meeting the oxygen output requirements.

### BRIEF DESCRIPTION OF THE DRAWINGS

FIG. 1. A graphical representation of the oxygen flow profile for one embodiment of the invention.

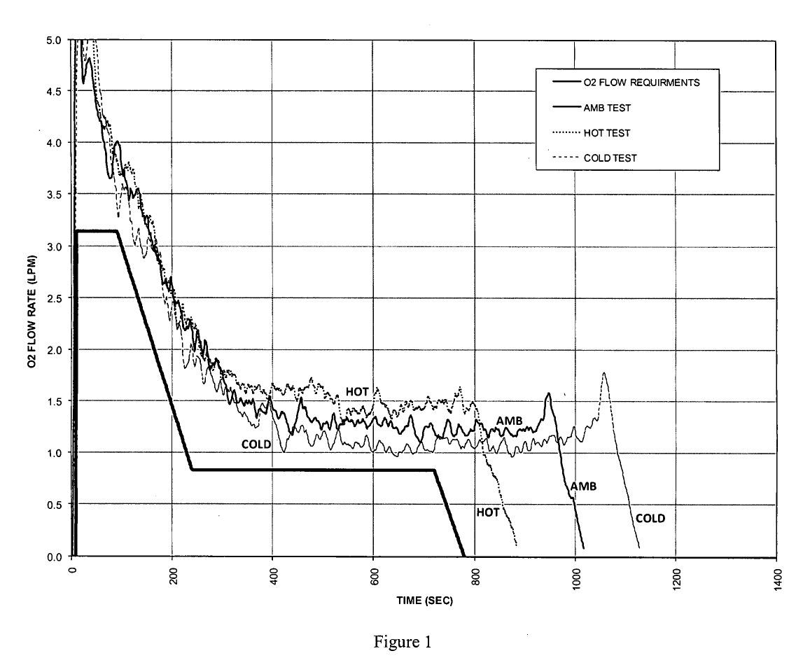

FIG. 2. A graphical representation of the oxygen flow profile for a prior art composition.

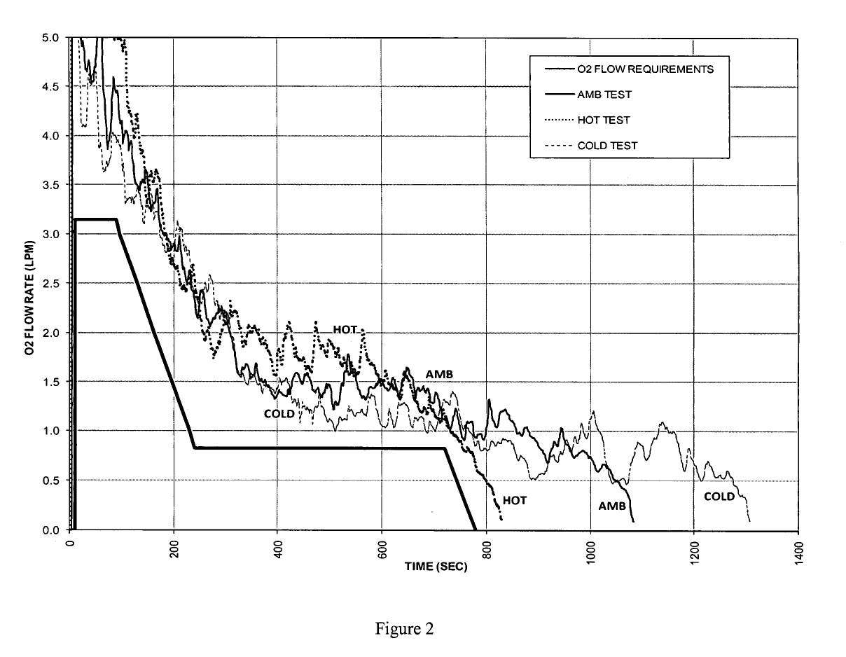

### DETAILED DESCRIPTION OF THE INVENTION

The present invention provides compositions capable of generating oxygen upon thermal decomposition. The compositions are suitable for incorporation into conventional oxygen generating candles. In one embodiment, the compositions comprise a metal fuel, a transition metal oxide catalyst, a reaction moderator, a binder, an O₂ source, and an additive, wherein the additive is feldspar, anhydrous aluminum silicate, or combinations thereof, used together with or without other inert additives.

The present invention is based on the unexpected finding that oxygen generating compositions disclosed herein comprising feldspar and anhydrous aluminum silicate produce decreased amounts of chlorine gas, require less inert binders to control the rate of oxygen generation, and are significantly less sensitive to environmental temperature extremes when generating oxygen than conventional compositions such as those based on barium.

Without intending to be bound by any particular theory, it is considered that the additives disclosed herein function in the compositions of the invention in at least one of the following ways during decomposition (burning) of the candle: suppresses formation of residual chlorine; acts as a binder; acts as a reaction moderator; and acts to assist in smoothing oxygen evolution from the candle. They further aid in mixing the chemical components of a sustaining mix composition by helping lead to a more uniform distribution of particles.

It will be understood by those skilled in the art that candles incorporating a composition of the invention may be used in connection with any number of oxygen generating devices, in addition to conventional candles. When the composition of the invention is provided as part of an oxygen generating candle, the candle may be designed to meet specific regulatory requirements, such as those related to use of such candles on aircraft with respect to rates of oxygen generation and levels of chlorine release associated therewith.

In one embodiment of the present invention the oxygen generating composition is incorporated into an oxygen generating candle, and the candle typically includes a pyrotechnic powder and an ignition mix layer for initiation of the candle, and at least one sustaining mix layer. The pyrotechnic powder may be in the form of a loose powder, a compacted layer on the top of the candle, a pellet pressed into the candle, or packed in a metal tube that is pressed into the candle. The ignition mix layer typically consists of a fuel and or catalyst rich mixture, a binder, and an oxygen source. The initiation of the candle may also be achieved by the heating of the composition to its decomposition temperature by any practical means, including by flame for example.

A sustaining mix layer is herein defined as a uniform mixture of chemical constituents in a fixed-size chemical core that produces oxygen at a pre-determined rate and for a given amount of time.

In one embodiment, a composition of the invention suitable for use in a sustaining mix layer of an oxygen generating candle comprises an alkali metal chlorate or perchlorate oxygen source, a metal powder fuel, a transition metal oxide catalyst, binder(s), and an additive selected from about 0.10% to 10.00% feldspar, from 0.10% to 3.00% anhydrous aluminum silicate, or one or more combinations of feldspar and anhydrous aluminum silicate in such ranges. In a preferred sustaining mix layer formulation, the non-additive components include sodium chlorate as the oxygen sources, iron metal powder as a fuel, manganese oxide as a transition metal catalyst, potassium hydroxide and/or potassium permanganate as reaction moderators, amorphous silicon dioxide (e.g., non-crystalline fumed silica or silica flour) and/or mica as binders, and both of the additives, feldspar and anhydrous aluminum silicate.

Feldspar is the mineral name given to a group of minerals distinguished by the presence of aluminum (Al) and the silica ion in their chemistry. This group includes aluminum silicates of soda (sodium oxide), potassium (potassium oxide), or lime (calcium oxide). The general formula, for the common feldspars, is XAl₍₁₋₂₎Si₍₃₋₂₎O₈. The X in the formula can be sodium (Na) and/or potassium (K) and/or calcium (Ca). Feldspar is thus compositionally a mixture of Al₂O₃, SiO₂, and/or Na₂O, and/or K₂O and/or CaO. The different feldspars are distinguished by structure and chemistry. The potassium or K-feldspars, also known as alkali feldspars, are polymorphs, meaning they have the same chemistry, KAlSi₃O₈, but different structures. The plagioclase feldspars are a set of minerals that are in a series from a sodium-rich end member, albite, to a calcium-rich end member, anorthite. The intermediate members of the series are given boundaries based on their percentage of sodium or calcium. Often, feldspars are simply referred to as plagioclase (sodium and/or calcium based feldspars) and alkali (a K-feldspar) feldspar.

While feldspar contains sodium oxide (Na₂O), and/or potassium oxide (K₂O) and/or calcium oxide (CaO), these chemical constituents of feldspar, as individual compounds, are very caustic, reactive, and difficult to utilize in the laboratory. Our data demonstrates that when these constituents are components of feldspar they are protected or shielded and become non-reactive to water/moisture and to CO₂ absorption. However, when present as feldspar, these constituents are suitable for either wet or dry processing methods, are more easily handled relative to the individual chemical compounds, and can be handled in environments that do not require strict humidity control. This effect herein is referred to as ‘shielding.’ Thus, the use of feldspar allows for much easier incorporation of these compounds into oxygen generating candles to thereby take advantage of their ability to assist in the generation of oxygen in a more uniform fashion while producing reduced levels of chlorine contamination.

Plagioclase feldspars suitable for use in an oxygen candles include Albite (sodium aluminum silicate, NaAlSi₃O₈), Oligoclase (sodium calcium aluminum silicate, Na(70-90%)Ca(10-30%)(Al,Si)AlSi₂O₈), Andesine, (sodium calcium aluminum silicate, Na(50-70%)Ca(30-50%)(Al,Si)AlSi₂O₈), Labradorite, (calcium sodium aluminum silicate, Ca(50-70%)Na(30-50%)(Al,Si)AlSi₂O₈), Bytownite, (calcium sodium aluminum silicate, Ca(70-90%)Na(10-30%)(Al,Si)AlSi₂O₈), and Anorthite, (calcium aluminum silicate, CaAl₂Si₂O₈).

Alkali feldspars suitable for use in oxygen candles include Microcline, (Potassium aluminum silicate, KAlSi₃O₈), Orthoclase, (potassium aluminum silicate, KAlSi₃O₈), Sanidine (potassium sodium aluminum silicate, (K,Na)AlSi₃O₈), and Anorhtoclase (potassium sodium aluminum silicate, (K,Na)AlSi₃O₈). The approximate chemical composition of the Plagioclase and Alkali feldspars are summarized in Table 1.

TABLE 1

| | | COMPONENTS OF FLEDSPAR | | | | |
|---|---|---|---|---|---|---|
| FELDSPARS | | K₂O | Na₂O | CaO | Al₂O₃ | SiO₂ |
| ALKALI | Microcline | 16.90% | 0.00% | 0.00% | 18.32% | 64.76% |
| FELDSPARS | Orthoclase | 16.92% | trace | 0.00% | 18.32% | 64.76% |
| | Sanidine | 12.88% | 2.82% | 0.00% | 18.59% | 65.71% |
| | Anorthoclase | 4.42% | 8.73% | 0.00% | 19.15% | 65.71% |
| PLAGIOCLASE | Albite | 0.00% | 11.19% | 1.07% | 20.35% | 67.39% |
| FELDSPARS | Oligoclase | 0.00% | 9.34% | 4.23% | 23.05% | 63.38% |
| | Andesine | 0.00% | 6.92% | 8.35% | 26.57% | 58.16% |
| | Labadorite | 0.00% | 4.56% | 12.30% | 30.01% | 53.05% |
| | Bytownite | 0.00% | 2.25% | 16.31% | 33.37% | 48.07% |
| | Anorthite | 0.00% | 0.56% | 19.20% | 35.84% | 44.40% |
| | RANGE | 0-17% | 0-12% | 0-20% | 18-36% | 44-70% |

In one embodiment, the additive is feldspar alone. Suitable feldspars can be selected from the Plagioclase or alkali feldspars.

In one embodiment, a composition of the invention includes feldspar as the additive, where the feldspar is comprised of from 0-17% K₂O, 0-12% Na₂O, 0-20% CaO, 18-36% Al₂O₃, and 44-70% SiO₂. As note above, if the feldspar is an Alkali feldspar, the percentage of K₂O is greater than 0% and the percentage of CaO is equal to 0%. Furthermore, if the feldspar is Plagioclase feldspar, the percentage of K₂O is equal to 0% and the percentage of CaO is greater than 0%. Typically, as feldspar is a naturally occurring material, a typical feldspar is a mixture of Alkali and Plagioclase feldspars and both K₂O and CaO are greater than 0%.

In one embodiment, the invention comprises a typical feldspar, such as a feldspar that is commercially available from the UNIMIN Corporation. This typical feldspar provided by the UNUMIN Corporation has the approximate chemical composition of 4.5% K₂O, 6.5 Na₂₀, 1.6% CaO, 19% Al₂O₃, 68% SiO₂, and trace (<0.1%) Fe₂O₃ and is likely a mixture of Anorthoclase and Albite feldspars.

In one embodiment, the invention comprises one or more sustaining mix layers that incorporate the typical feldspar described above at a maximum concentration of 3.0% of feldspar. When at a maximum concentration for said typical feldspar of 3% in a sustaining mix layer, the maximum concentration of each of the components of the feldspars in the mix are 0.135% K₂O, 0.195% Na₂O, 0.048% CaO, 0.570% Al₂O₃, 2.040% SiO₂, Fe₂O₃<0.001%.

Anhydrous aluminum silicate as described herein is a mixture of SiO₂ and Al₂O₃ that is formed through a high temperature calcination of kaolinite clay. The high temperature calcination process is believed to destroy the matrix (or structure) of kaolinite clay. Accordingly, anhydrous aluminum silicate is a “calcined kaolin” that has been converted by thermal methods from the corresponding (and naturally occurring) hydrous kaolin to the dehydroxylated form. The terms “anhydrous aluminum silicate” and “calcined kaolin” are accordingly used interchangeably herein.

The process of calcination changes, among other properties, the kaolin structure from crystalline to amorphous. Calcination may be effected by heat-treating coarse or fine hydrous kaolin in any known manner, e.g., at temperatures ranging from 500° C. to over 1200° C.

The degree to which hydrous kaolin undergoes changes in crystalline form can depend upon the amount of heat to which the hydrous kaolin is subjected. At temperatures below a maximum of about 850-900° C., the product is often considered to be virtually dehydroxylated, with the resultant amorphous structure commonly referred to as a metakaolin. Frequently, calcination at this temperature is referred to as “partial calcination,” and the product may also be referred to as “partially calcined kaolin.” Further heating to temperatures above about 900-950° C. can result in further structural changes, such as densification. Calcination at these higher temperatures is commonly referred to as “full calcination,” and the product is commonly referred to as “fully calcined kaolin”.

Effective calcining procedures include, but are not limited to, soak calcining and flash calcining. In soak calcining, a hydrous kaolin is heat treated at temperatures ranging from 500° C. to 1200° C. In particular embodiments, such as temperatures ranging from 800° C. to 1200° C., from 850-900° C., or from 900-950° C., for a period of time (e.g., from at least 1 minute to 5 or more hours) sufficient to dehydroxylate the kaolin. In flash calcining, a hydrous kaolin is heated rapidly for a period of less than 1 second, typically less than 0.5 second, to extremely high temperatures.

A furnace, kiln, or other heating apparatus used to effect calcining of the hydrous kaolin may be of any known kind. Known devices suitable for carrying out soak calcining include high temperature ovens and rotary and vertical kilns. Known devices for effecting flash calcining include toroidal fluid flow heating devices known to those skilled in the art.

One form of anhydrous aluminum silicate that has been found useful is available from the Burgess Pigment Company under the trade-name ICECAP K and has component amounts in the ranges of approximately 48-52% SiO₂, 40-44% Al₂O₃, and 2-3% TiO₂. Of particular importance is our determination that lesser amounts of anhydrous aluminum silicate are required to moderate the candle decomposition reaction than for other typical inert inorganic refractory materials. In this regard, an oxygen candle incorporating the composition of the present invention will use less anhydrous aluminum silicate in its formulation than the total amount of other typical inert inorganic refractory materials (such as SiO₂, Al₂O₃, TiO₂) to achieve a similar decomposition rate or oxygen flow. As a consequence of using less inert inorganic refractory in the candle formulation, more chlorate or perchlorate oxygen source can be available in the candle. Alternatively, in lieu of using more chlorate or perchlorate for oxygen, the size and the weight of the oxygen candle may be reduced while still being capable of meeting given oxygen flow requirements.

While testing various embodiments of the invention, it was unexpectedly discovered that oxygen candles with chemical formulations of the present invention comprising feldspar and anhydrous aluminum silicate are significantly less sensitive to environmental temperature extremes when generating oxygen. The differential in oxygen evolution durations between hot and cold temperature extremes was significantly smaller for Improved Core Chemistry formulations, which contain feldspar and AAS (composition described in Table 8), than for Existing Core Chemistry (composition containing barium oxide as described in the Background section) formulations (see Table 2). Likewise, the differential in oxygen evolution flow rates between hot and cold temperature extremes was significantly smaller for Improved Core Chemistry formulations than for Existing Core Chemistry formulations (see Table 2). The data represented in Table 2 was acquired using an ambient temperature of 22° C.±3° C. (72° F.±5° F.), a hot temperature of 55° C.±3° C. (131° F.±5° F.), and a cold temperature of −15° C.±3° C. (5° F.±5° F.).

TABLE 2
Comparison of Improved and Existing Core Chemistries

| | |
|---|---|
| Improved Core | Existing Core |
| Chemistry | Chemistry |

| | | | | |
|---|---|---|---|---|
| Average Ambient Duration | 16.9 | minutes | 17.8 | minutes |
| Average Hot Duration | 14.8 | minutes | 13.6 | minutes |
| Average Cold Duration | 18.7 | minutes | 21.3 | minutes |
| Differential Between Hot | 3.9 | minutes | 7.7 | minutes |
| and Cold Duration | | | | |
| Average Ambient Flow Rate | 1.15 | LPM | 1.45 | LPM |
| Average Hot Flow Rate | 1.31 | LPM | 1.90 | LPM |
| Average Cold Flow Rate | 1.00 | LPM | 1.10 | LPM |
| Differential Between Hot and | 0.31 | LPM | 0.80 | LPM |
| Cold Flow Rates | | | | |

LPM = liters of oxygen gas per minute

As a consequence of being less sensitive to operational temperature extremes, an oxygen generating candle comprising oxygen generating compositions of the present invention can be designed smaller in size and weight, while still complying with minimum oxygen output requirements when operated at the high and low specified temperatures, when compared with other inorganic refractory materials (e.g. SiO₂, Al₂O₃, and TiO₂). Conversely, in lieu of using a smaller candle or for candles fixed in size, the candle can be designed to contain more chlorate or perchlorate for oxygen evolution and thereby provide a greater margin in oxygen flow rate or duration, or both.

The invention will be further described by the examples presented below. These examples are illustrative and not intended to be restrictive in any way.

### EXAMPLE 1

Examples 1-3 demonstrate the effect of feldspar in an oxygen generating composition of the invention. The following parameters apply to Example 1.
Mix I: 1.97% Feldspar, 89.05% NaClO₃, 2.47% Fe, 1.28% MnO₂, 1.27% KOH, 2.96% mica, 0.50% anhydrous aluminum silicate, 0.50% fumed silica.
Mix II: 1.48% Feldspar, 89.35% NaClO₃, 2.47% Fe, 1.97% MnO₂, 1.27% KOH, 3.46% mica.
Mix III: 0.99% Feldspar, 89.45% NaClO₃, 2.86% Fe, 1.48% MnO₂, 1.27% KOH, 2.96% mica, 0.50% silica flour, 0.50% fumed silica.
   Mixes I, II, and III are formulations all containing different percentages of feldspar.

TABLE 3

| | FORMULATION/COMPONENTS | | | | | | | | | |
|---|---|---|---|---|---|---|---|---|---|---|
| | | | | | | | | % OTHER | OUTPUT | |
| | | % COMPONENT | | | | | % Anhydrous | MICA, | AVE | AVE |
| | | (SiO2/Al2O3) | | | | | Aluminum | Cabosil | FLOW | [Cl2] |
| MIX | % FELDSPAR | of FELDSPAR | % NaClO3 | % Fe | % MnO2 | % KOH | Silicate | SiO2 | LPM | PPM |
| I | 1.97 | 0.00 | 89.05 | 2.47 | 1.28 | 1.27 | 0.50 | 3.46 | ~1.2 | ~170 |
| II | 1.48 | 0.00 | 89.35 | 2.47 | 1.97 | 1.27 | 0.00 | 3.46 | ~1.6 | ~200 |
| III | 0.99 | 0.00 | 89.45 | 2.86 | 1.48 | 1.27 | 0.00 | 3.96 | ~1.7 | ~290 |

As can be seen from Table 3, using feldspar as an additive in an oxygen candle sustaining mix formulation reduces the concentration of chlorine in the output. Specifically, as the concentration of feldspar is increased, from Mix III to Mix II to Mix I, average the concentration of chlorine in the generated oxygen decreases, from 290 ppm to 200 ppm to 170 ppm, respectively.

### EXAMPLE 2

The following parameters apply to Example 2:
Mix I: 1.97% Feldspar, 89.05% NaClO₃, 2.47% Fe, 1.28% MnO₂, 1.27% KOH, 2.96% mica, 0.50% anhydrous aluminum silicate, 0.50% fumed silica.
Mix A: 0.00% Feldspar, 91.02% NaClO₃, 2.47% Fe, 1.28% MnO₂, 1.27% KOH, 2.96% mica, 0.50% anhydrous aluminum silicate, 0.50% fumed silica.
Mix B: 0.00% Feldspar, 89.31% NaClO₃, 2.47% Fe, 1.28% MnO₂, 1.27% KOH, 2.96% mica, 0.50% anhydrous aluminum silicate, 0.50% fumed silica, 1.34% SiO₂, 0.38% Al₂O₃.
Mix C: 0.00% Feldspar, 89.05% NaClO₃, 2.47% Fe, 1.28% MnO₂, 1.27% KOH, 4.44% mica, 0.74% anhydrous aluminum silicate, 0.74% fumed silica.

Mixes A, B, and C are permutations of Mix I where Mix A maintains a constant % Other and increases the % of NaClO₃ in place of the feldspar, Mix B contains the components of feldspar in place of the feldspar, and Mix C maintains a constant % NaClO₃ and increases the % Other in place of the feldspar. The data is summarized in Table 4.

TABLE 4

| | FORMULATION/COMPONENTS | | | | | | | | | |
|---|---|---|---|---|---|---|---|---|---|---|
| | | | | | | | | % OTHER | OUTPUT | |
| | | % COMPONENT | | | | | % Anhydrous | MICA, | AVE | AVE |
| | | (SiO2/Al2O3) | | | | | Aluminum | Cabosil | FLOW | [Cl2] |
| MIX | % FELDSPAR | of FELDSPAR | % NaClO3 | % Fe | % MnO2 | % KOH | Silicate | SiO2 | LPM | PPM |
| I | 1.97% | 0.00% | 89.05% | 2.47% | 1.28% | 1.27% | 0.50% | 3.46% | ~1.2 | ~170 |
| A | 0.00% | 0.00% | 91.02% | 2.47% | 1.28% | 1.27% | 0.50% | 3.46% | ~1.4 | ~275 |
| B | 0.00% | 1.72% | 89.31% | 2.47% | 1.28% | 1.27% | 0.50% | 3.46% | ~1.3 | ~350 |
| C | 0.00% | 0.00% | 89.05% | 2.47% | 1.28% | 1.27% | 0.75% | 5.18% | ~1.2 | ~390 |

It can be seen from the data provided in Table 4 that an oxygen generating composition comprising feldspar as an additive in, in this embodiment, the mix layer, reduces the concentration of chlorine when compared to candle mix formulations without feldspar or candle mix formulations that contained the inert components of feldspar (i.e., SiO₂ and Al₂O₃). Specifically, a mix formulation containing feldspar, Mix I, depicted a lower concentration of chlorine, 170 ppm, than mix formulations without feldspar or mix formulations that contained the inert components of feldspar, Mixes A, B, and C, 275 ppm, 350 ppm, 390 ppm, respectively. Thus, feldspar is superior in chlorine reduction when compared to its constituent parts independent of association in feldspar.

### EXAMPLE 3

The following parameters apply to Example 3:
Mix II: 1.48% Feldspar, 89.35% NaClO₃, 2.47% Fe, 1.97% MnO₂, 1.27% KOH, 3.46% mica.
Mix D: 0.00% Feldspar, 89.35% NaClO₃, 2.47% Fe, 1.97% MnO₂, 1.27% KOH, 3.46% mica, 1.48% anhydrous aluminum silicate.
Mix E: 0.00% Feldspar, 89.35% NaClO₃, 2.47% Fe, 1.97% MnO₂, 1.27% KOH, 3.46% mica, 1.48% Olivine.
Mix III: 0.99% Feldspar, 89.45% NaClO₃, 2.86% Fe, 1.48% MnO₂, 1.27% KOH, 2.96% mica, 0.50% silica flour, 0.50% fumed silica.
Mix F: 0.00% Feldspar, 89.45% NaClO₃, 2.86% Fe, 1.48% MnO₂, 1.27% KOH, 2.96% mica, 0.99% TiO₂, 0.50% fumed silica, 0.50% SiO₂.
Mix G: 0.00% Feldspar, 89.45% NaClO₃, 2.86% Fe, 1.48% MnO₂, 1.27% KOH, 2.96% mica, 0.99% anhydrous aluminum silicate, 0.50% fumed silica, 0.50% SiO₂.

Mixes D and E are permutations of Mix II where Mix D replaces the % feldspar with anhydrous aluminum silicate and Mix E replaces the % feldspar with olivine. Likewise, Mixes F and G are permutations of Mix III where Mix F replaces the % feldspar with titanium dioxide and Mix G replaces the % feldspar with anhydrous aluminum silicate. The data is summarized in Table 5.

TABLE 5

| | FORMULATION/COMPONENTS | | | | | | | | | |
|---|---|---|---|---|---|---|---|---|---|---|
| | | | | | | | | % OTHER | | |
| | | | | | | | | MICA, | OUTPUT | |
| | | % COMPONENT | | | | | % Anhydrous | Cabosil | AVE | AVE |
| | | (SiO2/Al2O3) | | | | | Aluminum | SiO2, | FLOW | [Cl2] |
| MIX | % FELDSPAR | of FELDSPAR | % NaClO3 | % Fe | % MnO2 | % KOH | Silicate | Olivine | LPM | PPM |
| II | 1.48 | 0.00 | 89.35 | 2.47 | 1.97 | 1.27 | 0.00 | 3.46 | ~1.6 | ~200 |
| D | 0.00 | 0.00 | 89.35 | 2.47 | 1.97 | 1.27 | 1.48 | 3.46 | ~1.7 | ~275 |
| E | 0.00 | 0.00 | 89.35 | 2.47 | 1.97 | 1.27 | 0.00 | 4.94 | ~1.6 | ~275 |
| III | 0.99 | 0.00 | 89.45 | 2.86 | 1.48 | 1.27 | 0.00 | 3.96 | ~1.7 | ~290 |
| F | 0.00 | 0.00 | 89.45 | 2.86 | 1.48 | 1.27 | 0.00 | 4.95 | ~1.6 | ~375 |
| G | 0.00 | 0.00 | 89.45 | 2.86 | 1.48 | 1.27 | 0.99 | 3.96 | ~1.4 | ~430 |

As can be seen from Table 5, the data demonstrate that the presence of feldspar in an oxygen candle mix formulation reduces the concentration of chlorine when compared to candle mix formulations without feldspar. Specifically, the mix formulation containing feldspar, Mix II, depicted a lower concentration of chlorine, 200 ppm, than mix formulations without feldspar, Mixes D and E, 275 ppm and 275 ppm, respectively, in the generated oxygen as depicted in the data table below. Likewise, the mix formulation containing feldspar, Mix III depicted a lower concentration of chlorine, 290 ppm, than mix formulations without feldspar, Mixes F and G, 375 ppm and 430 ppm, respectively.

Thus, the foregoing examples demonstrate that oxygen generating candle mix formulations comprising feldspar at 0.01% to 10.00% result in a more uniform oxygen evolution and suppressed residual chlorine levels than oxygen generating candles that did not contain feldspar, contained only the components of feldspar in place of the feldspar, or contained other, distinct inert components.

### EXAMPLE 4

This example demonstrates the effect of anhydrous aluminum silicate in an oxygen generating composition of the invention. In particular, oxygen generating candle mix formulations utilizing anhydrous aluminum silicate at 0.01% to 3.00% depicted slower oxygen evolution (flow) rates than candles of similar composition that contained only the components of anhydrous aluminum silicate in place of it.
Mix A1: 0.494% anhydrous aluminum silicate, 87.390% NaClO₃, 2.962% Fe, 3.456% MnO₂, 0.987% Feldspar, 0.962% mica, 0.494% fumed silica, 1.254% KOH.
Mix A2: 0.987% anhydrous aluminum silicate, 86.896% NaClO₃, 2.962% Fe, 3.456% MnO₂, 0.987% Feldspar, 2.962% mica, 0.494% fumed silica, 1.254% KOH.
Mix A3: 1.481% anhydrous aluminum silicate, 86.403% NaClO₃, 2.962% Fe, 3.456% MnO₂, 0.987% Feldspar, 2.962% mica, 0.494% fumed silica, 1.254% KOH.
Mix A4: 1.975% anhydrous aluminum silicate, 85.909% NaClO₃, 2.962% Fe, 3.456% MnO₂, 0.987% Feldspar, 2.962% mica, 0.494% fumed silica, 1.254% KOH.
Mix A5: 2.469% anhydrous aluminum silicate, 85.415% NaClO₃, 2.962% Fe, 3.456% MnO₂, 0.987% Feldspar, 2.962% mica, 0.494% fumed silica, 1.254% KOH.
Mix C1: 0.523% SiO₂, 0.434% Al₂O₃, 0.030% TiO₂, 86.896% NaClO₃, 2.962% Fe, 3.456% MnO₂, 0.987% Feldspar, 2.962% mica, 0.494% fumed silica, 1.254% KOH.
Mix C2: 1.047% SiO₂, 0.869% Al₂O₃, 0.059% TiO₂, 85.909% NaClO₃, 2.962% Fe, 3.456% MnO₂, 0.987% Feldspar, 2.962% mica, 0.494% fumed silica, 1.254% KOH.
Mix C3: 1.313% SiO₂, 1.086% Al₂O₃, 0.069% TiO₂, 85.415% NaClO₃, 2.962% Fe, 3.456% MnO₂, 0.987% Feldspar, 2.962% mica, 0.494% fumed silica, 1.254% TiO₂.
Mix C4: 1.837% SiO₂, 1.521% Al₂O₃, 0.099% TiO₂, 84.428% NaClO₃, 2.962% Fe, 3.456% MnO₂, 0.987% Feldspar, 2.962% mica, 0.494% fumed silica, 1.254% TiO₂.

TABLE 6

| | Anhydrous | | | | | | | | | | |
|---|---|---|---|---|---|---|---|---|---|---|---|
| | Aluminum | | | | | | | | | | |
| | Silicate | SiO₂ | Al₂O₃ | TiO2 | NaClO₃ | Fe | MnO₂ | Feldspar | MICA | CAB | KOH |
| MIX | % OF COMPONENTS IN MIX | | | | | | | | | | |
| A1 | 0.494 | x | x | x | 87.39 | 2.962 | 3.456 | 0.987 | 2.962 | 0.494 | 1.254 |
| A2 | 0.987 | x | x | x | 86.90 | 2.962 | 3.456 | 0.987 | 2.962 | 0.494 | 1.254 |
| A3 | 1.481 | x | x | x | 86.40 | 2.962 | 3.456 | 0.987 | 2.962 | 0.494 | 1.254 |
| A4 | 1.975 | x | x | x | 85.91 | 2.962 | 3.456 | 0.987 | 2.962 | 0.494 | 1.254 |
| A5 | 2.469 | x | x | x | 85.42 | 2.962 | 3.456 | 0.987 | 2.962 | 0.494 | 1.254 |
| C1 | x | 0.523 | 0.434 | 0.030 | 86.90 | 2.962 | 3.456 | 0.987 | 2.962 | 0.494 | 1.254 |
| C2 | x | 1.047 | 0.869 | 0.059 | 85.91 | 2.962 | 3.456 | 0.987 | 2.962 | 0.494 | 1.254 |
| C3 | x | 1.313 | 1.086 | 0.069 | 85.46 | 2.962 | 3.456 | 0.987 | 2.962 | 0.494 | 1.254 |
| C4 | x | 1.837 | 1.521 | 0.099 | 84.43 | 2.962 | 3.456 | 0.987 | 2.962 | 0.494 | 1.254 |

TABLE 7

| | | | Components | | |
|---|---|---|---|---|---|
| | OB- | | of AAS | | % |
| | SERVED | Anhydrous | (SiO₂, | | AVAIL- |
| | FLOW | Aluminum | Al₂O₃, | | ABLE |
| | RATE | Silicate | TiO₂) | NaClO₃ | OXYGEN |
| MIX | LPM | % | % | % | % |
| A1 | 1.19 | 0.494 | X | 87.39 | 39.41 |
| A2 | 1.17 | 0.987 | X | 86.90 | 39.18 |
| A3 | 1.14 | 1.481 | X | 86.40 | 38.96 |
| A4 | 1.11 | 1.975 | X | 85.91 | 38.74 |
| A5 | 1.07 | 2.469 | X | 85.42 | 38.52 |
| C1 | 1.31 | X | 0.987 | 86.90 | 39.18 |
| C2 | 1.29 | X | 1.975 | 85.91 | 38.74 |
| C3 | 1.25 | X | 2.468 | 85.46 | 38.52 |
| C4 | 1.25 | X | 3.457 | 84.43 | 38.07 |

The data presented in Tables 6 and 7 demonstrate that utilizing anhydrous aluminum silicate in oxygen candle mix formulations produces lower oxygen flow outputs (rates) than similar candles that utilized the same percentage of material but only as the components of anhydrous aluminum silicate, specifically silicon dioxide, SiO₂, aluminum dioxide, Al₂O₃, and titanium dioxide, TiO₂. In particular, Mix A2 (0.987% anhydrous aluminum silicate) produced O₂ at the rate of 1.17 lpm (or L/min), significantly slower than Mix C1 (0.987% total for SiO₂+Al₂O₃+TiO₂) that produced O₂ at the rate of 1.31 lpm. Likewise, Mix A4 (1.975% anhydrous aluminum silicate) produced O₂ at the rate of 1.11 lpm, and again significantly slower than Mix C2 (1.975% total for SiO₂+Al₂O₃+TiO₂) that produced O₂ at the rate of 1.29 lpm. And finally, Mix A5 (2.469% anhydrous aluminum silicate) produced O₂ at the rate of 1.07 lpm, and again significantly slower than Mix C3 (2.469% total for SiO₂+Al₂O₃+TiO₂) that produced O₂ at the rate of 1.25 lpm. All these results are depicted in the following data table.

It is important to note that O₂ flow rates equal to that produced by a candle mix formulation utilizing the minimum amount of anhydrous aluminum silicate (1.19 lpm) could not be achieved by a candle mix formulation utilizing up to 3.457% (observed to flow at 1.25 lpm) of the components of anhydrous aluminum silicate, SiO₂, Al₂O₃, and TiO₂, in place of the anhydrous aluminum silicate.

The test data of Tables 6 and 7 also demonstrates that oxygen candle sustaining mix formulations utilizing anhydrous aluminum silicate have greater available oxygen content than similar candles with sustaining mix formulations that utilized only the components of anhydrous aluminum silicate, silicon dioxide, SiO₂, aluminum dioxide, Al₂O₃, and titanium dioxide, TiO₂, in its place. Specifically, Mix A1 (0.494% anhydrous aluminum silicate) produced an oxygen flow rate of 1.19 lpm at a percent of available oxygen of 39.41%. In the closest comparison of oxygen output, Mix C4 (3.46% total inorganic components) produced an oxygen flow rate of 1.25 lpm at a percent of available oxygen of 38.07% as depicted in the following data table. Mix C4 contains 1.34% less available oxygen than does Mix A1.

Representative ranges for components of compositions of the present invention comprising from 0.1 to 3.0% feldspar and from 0.1 to 3.0% anhydrous aluminum silicate, with each also expressed as a percentage of a sustaining mix, are presented in Table 8.

TABLE 8
EXAMPLE CANDLE

| LAYER | COMPONENTS | COMPONENTS (% IS FOR MIX LAYER) | | | |
|---|---|---|---|---|---|
| 1 | Pyrotechnic | Fuel | Ti | 12-13% | |
| | Powder | Reaction Moderator | TiO₂ | 67-68% | |
| | (Flash Tube, | Binder/Other | Fe₂O₃ | 0.5-0.6% | |
| | Layer, | O₂ Source | KClO₄ | 19-20% | |
| | Pellet, Pocket) | | | | |
| 2 | Ignition Mix | Fuel | Fe, Co | 5-30% | |
| | | Transition Metal | MnO₂, Mn₂O₃, Mn₃O₄, | 1-20% | |
| | | Catalyst | Co₃O₄, Fe₂O₃ | | |
| | | Reaction Moderator | KMnO₄ | 0%-5% | |
| | | Binder | MgAl₂O₄ (“spinnel”) | 10-30% | |
| | | O₂ Source | NaClO₃ | 35-79% | |
| 3 | Sustaining Mix | Fuel | Fe, Co | 0.1-8% | |
| | (LEAD) | Transition Metal | MnO₂, Mn₂O₃, Mn₃O₄, | 0.1-10% | |
| | | Catalyst | Co₃O₄, Fe₂O₃ | | |
| | | Reaction Moderator | KMnO₄ and KOH | 0.1-5% + 0.0-5% | |
| | | Binder | MICA | 0.1-4.4% | |
| | | | SiO₂ (cabosil, flour) | 0.1-3% | |
| | | O₂ Source | NaClO₃ | 60-90% | |
| 4-5 | Sustaining Mixes | Fuel | Fe, Co | 0.1-8% | |
| | (MID) | Transition Metal | MnO₂, Mn₂O₃, Mn₃O₄, | 0.1-8% | |
| | | Catalyst | Co₃O₄, Fe₂O₃ | | |
| | | Reaction Moderator | KOH | 0.1-5% | |
| | | Binder | MICA | 0.1-4.4% | |
| | | | SiO₂ (cabosil, flour) | 0.1-3% | |
| | | O₂ Source | NaClO₃ | 60-92% | |
| 6 | Sustaining Mix | Fuel | Fe, Co | 0.1-8% | |
| | (TAIL) | Transition Metal | MnO₂, Mn₂O₃, Mn₃O₄, | 0.1-5% | |
| | | Catalyst | Co₃O₄, Fe₂O₃ | | |
| | | Reaction Moderator | KOH | 0.1-5% | |
| | | Binder | MICA | 0.1-4.4% | |
| | | | SiO₂ (cabosil, flour) | 0.0-2% | |
| | | Additive | FELDSPAR | 0.1-3.0% | |
| | | | Components in Feldspar: | SiO₂ (68%) | 2.040% |
| | | | Percentage for component | Al₂O₃ (19%) | 0.570% |
| | | | in Feldspar shown in | Na₂O (6.5%) | 0.195% |
| | | | parentheses, percentage | K₂O (4.5%) | 0.135% |
| | | | to far right is for amount in | CaO (1.6%) | 0.048% |
| | | | mix layer at maximum | Fe₂O₃ (trace) | <0.01% |
| | | | Feldspar content, 3.0%. | | |
| | | | ANHYDROUS | 0.1-3.0% | |
| | | | ALUMINUM SILICATE | | |
| | | | (AAS) | | |
| | | | Components in Anhydrous | SiO₂ | 1.560% |
| | | | Aluminum Silicate: | (48-52%) | |
| | | | Percentage for component | Al₂O₃ | 1.320% |
| | | | in Anhydrous Aluminum | (40-44%) | |
| | | | Silicate shown in | TiO₂ | 0.090% |
| | | | parentheses, percentage | (2-3%) | |
| | | | to far right is for amount in | | |
| | | | mix layer at maximum | | |
| | | | AAS content, 3.0%. | | |

| | | |
|---|---|---|
| O₂ Source | NaClO₃ | 60-92% |

We claim:

1) An oxygen generating composition suitable for producing breathable oxygen gas upon thermal decomposition of the composition, the composition comprising:
a metal powder fuel;
a transition metal oxide catalyst;
an oxygen source; and
an additive, wherein the additive is selected from the group consisting of feldspar, anhydrous aluminum silicate, and combinations thereof.

2) The oxygen generating composition of claim 1, wherein the oxygen generating composition further comprises:
a reaction moderator; and
a binder.

3) The oxygen generating composition of claim 2, the composition comprising:
a metal powder fuel selected from the group consisting of iron, cobalt, and combinations thereof;
a transition metal oxide catalyst selected from the group consisting of MnO₂, Mn₂O₃, Mn₃O₄, CO₃O₄, Fe₂O₃, and combinations thereof;
a reaction moderator selected from the group consisting of potassium permanganate, potassium hydroxide, mica, amorphous silicon dioxide, and combinations thereof;
a binder selected from the group consisting of amorphous silicon dioxide, mica, and combinations thereof;
an oxygen source selected from the group consisting of alkali metal chlorates, alkali metal perchlorates, and combinations thereof; and
the additive, wherein the additive is selected from the group consisting of feldspar, anhydrous aluminum silicate, and combinations thereof.

4) The oxygen generating composition of claim 3,
wherein the composition comprises approximately 0.1 to 8.0 percent by weight of the metal powder fuel, wherein the metal powder fuel is selected from the group consisting of iron, cobalt, and combinations thereof;
wherein the composition comprises approximately 0.1 to 10 percent by weight of the transition metal oxide catalyst, wherein the transition metal oxide catalyst is selected from the group consisting of MnO₂, Mn₂O₃, Mn₃O₄, CO₃O₄, Fe₂O₃, and combinations thereof;
wherein the composition comprises approximately 0.1 to 5.0 percent by weight of potassium hydroxide as the reaction moderator;
wherein the composition comprises approximately 0.1 to 4.4 percent by weight of the mica and approximately 0.0 to 2.0 percent by weight of the amorphous silicon dioxide as the binder;
wherein the composition comprises approximately 60 to 92 percent by weight sodium chlorate as the oxygen source; and
wherein the composition comprises approximately 0.1 to 3.0 percent by weight of the feldspar and approximately 0.1 to 3.0 percent by weight of the anhydrous aluminum silicate the additive.

5) The oxygen generating composition of claim 1, wherein the composition comprises approximately 0.1 to 10 percent by weight of feldspar.

6) The oxygen generating composition of claim 1, wherein the feldspar comprises:
approximately 68 percent by weight of silicon dioxide;
approximately 19 percent by weight of aluminum oxide;
approximately 6.5 percent by weight of sodium oxide;
approximately 4.5 percent by weight of potassium oxide; and
approximately 1.6 percent by weight of calcium oxide.

7) The oxygen generating composition of claim 1, wherein the feldspar comprises:
approximately 0 to 17 percent by weight of potassium oxide;
approximately 0 to 12 percent by weight of sodium oxide;
approximately 0 to 20 percent by weight of calcium oxide;
approximately 18 to 36 percent by weight of aluminum oxide; and
approximately 44 to 70 percent by weight of silicon dioxide.

8) The oxygen generating composition of claim 1, wherein the anhydrous aluminum silicate comprises:
approximately 50 percent by weight of silicon dioxide;
approximately 42 percent by weight of aluminum oxide; and
approximately 2.5 percent by weight of titanium dioxide.

9) The oxygen generating composition of claim 1, wherein the composition is capable of producing breathable oxygen gas at a flow rate of approximately 0.1 to 30 L/min.

10) The oxygen generating composition of claim 1, wherein the composition further comprises:
a pyrotechnic powder, wherein the pyrotechnic powder is in the form of a loose powder, a compacted layer on the top of the candle, a pellet pressed into the candle, or packed in a metal tube that is pressed into the candle; and
an ignition layer, wherein the ignition layer comprises a fuel and/or catalyst rich mixture, a binder, and an oxygen source.

11) An oxygen generating candle for producing breathable oxygen gas upon thermal decomposition of the candle, said candle comprising:
a plurality of layers of oxygen generating compositions, wherein at least one of the layers comprises:
a metal powder fuel;
a transition metal oxide catalyst;
an oxygen source; and
an additive, wherein the additive is selected from the group consisting of feldspar, anhydrous aluminum silicate, and combinations thereof,
the oxygen generating candle being operable for producing breathable oxygen for a period of at least several minutes.

12) The oxygen generating candle of claim 11, wherein at least one of the layers further comprises:
a reaction moderator; and
a binder;

13) The oxygen generating candle of claim 11, wherein the candle further comprises:
a pyrotechnic powder, wherein the pyrotechnic powder is in the form of a loose powder,
a compacted layer on the top of the candle, a pellet pressed into the candle, or packed in a metal tube that is pressed into the candle; and
an ignition layer, wherein the ignition layer comprises a fuel and/or catalyst rich mixture, a binder, and an oxygen source.

14) The oxygen generating candle of claim 12, wherein at least one of the layers comprises:
a metal powder fuel selected from the group consisting of iron, cobalt, and combinations thereof;
a transition metal oxide catalyst selected from the group consisting of MnO₂, Mn₂O₃, Mn₃O₄, CO₃O₄, Fe₂O₃, and combinations thereof;
a reaction moderator selected from the group consisting of potassium permanganate, potassium hydroxide, mica, amorphous silicon dioxide, and combinations thereof;
a binder selected from the group consisting of amorphous silicon dioxide, mica, and combinations thereof;
an oxygen source selected from the group consisting of alkali metal chlorates, alkali metal perchlorates, and combinations thereof; and
the additive, wherein the additive is selected from the group consisting of feldspar, anhydrous aluminum silicate, and combinations thereof.

15) The oxygen generating candle of claim 14 wherein at least one of the layers comprises:
approximately 0.1 to 8.0 percent by weight of the metal powder fuel, wherein the metal powder fuel is selected from the group consisting of iron, cobalt, and combinations thereof;
approximately 0.1 to 10 percent by weight of the transition metal oxide catalyst, wherein the transition metal oxide catalyst is selected from the group consisting of MnO₂, Mn₂O₃, Mn₃O₄, CO₃O₄, Fe₂O₃, and combinations thereof;
approximately 0.1 to 5.0 percent by weight of potassium hydroxide as the reaction moderator;
approximately 0.1 to 4.4 percent by weight of the mica and approximately 0.1 to 3 percent by weight of amorphous silicon dioxide as the binder;
approximately 60 to 92 percent by weight of the sodium chlorate as the oxygen source; and
approximately 0.1 to 3.0 percent by weight of the feldspar and approximately 0.1 to 3.0 percent by weight of the anhydrous aluminum silicate as the binder.

16) The oxygen generating candle of claim 11 wherein at least one of the layers comprises approximately 0.1 to 10 percent by weight of feldspar.

17) The oxygen generating candle of claim 11, wherein the feldspar comprises:
approximately 68 percent by weight of silicon dioxide;
approximately 19 percent by weight of aluminum oxide;
approximately 6.5 percent by weight of sodium oxide;
approximately 4.5 percent by weight of potassium oxide; and
approximately 1.6 percent by weight of calcium oxide.

18) The oxygen generating composition of claim 11, wherein the feldspar comprises:
approximately 0 to 17 percent by weight of potassium oxide;
approximately 0 to 12 percent by weight of sodium oxide;
approximately 0 to 20 percent by weight of calcium oxide;
approximately 18 to 36 percent by weight of aluminum oxide; and
approximately 44 to 70 percent by weight of silicon dioxide.

19) The oxygen generating candle of claim 11, wherein the anhydrous aluminum silicate comprises:
approximately 50 percent by weight of silicon dioxide;
approximately 42 percent by weight of aluminum oxide; and
approximately 2.5 percent by weight of titanium dioxide.

20) The oxygen generating candle of claim 11, wherein the candle is capable of producing breathable oxygen gas at a flow rate of approximately 0.1 to 30 L/min.

21) An improvement in an oxygen generating composition for producing breathable oxygen gas for at least several minutes upon thermal decomposition of the composition, the composition comprising:
a metal powder fuel;
a transition metal oxide catalyst;
an oxygen source;
wherein the improvement comprises:
an additive selected from the group consisting of feldspar, anhydrous aluminum silicate, and combinations thereof, wherein the additive is wet processible, and wherein the feldspar is incorporated into the composition for suppression of residual chlorine, and wherein the anhydrous aluminum silicate is incorporated into the composition to increase the available oxygen content of a candle comprising the oxygen generating composition or to decrease the size of a candle comprising the oxygen generating composition.

22) The oxygen generating composition of claim 21, wherein the oxygen generating composition further comprises:
a reaction rate moderator; and
a binder.

23) The oxygen generating composition from claim 22, the composition comprising:
a metal powder fuel selected from the group consisting of iron, cobalt, and combinations thereof;
a transition metal oxide catalyst selected from the group consisting of MnO₂, Mn₂O₃, Mn₃O₄, CO₃O₄, Fe₂O₃, and combinations thereof;
a reaction rate moderator selected from the group consisting of potassium permanganate, potassium hydroxide, mica, amorphous silicon dioxide, and combinations thereof;
a binder selected from the group consisting of amorphous silicon dioxide, and mica, and combinations thereof;
an oxygen source selected from the group consisting of alkali metal chlorates, alkali metal perchlorates, and combinations thereof; and
the additive selected from the group consisting of feldspar, anhydrous aluminum silicate, and combinations thereof.

24) The oxygen generating composition of claim 23,
wherein the composition comprises approximately 0.1 to 8.0 percent by weight of the metal powder fuel, wherein the metal powder fuel is selected from the group consisting of iron, cobalt, and combinations thereof;
wherein the composition comprises approximately 0.1 to 10 percent by weight of the transition metal catalyst, wherein the transition metal oxide catalyst is selected from the group consisting of MnO₂, Mn₂O₃, Mn₃O₄, CO₃O₄, Fe₂O₃, and combinations thereof;
wherein the composition comprises approximately 0.1 to 5.0 percent by weight potassium hydroxide as the reaction moderator;
wherein the composition comprises approximately 0.1 to 4.4 percent by weight of the mica and approximately 0.1 to 2.0 percent by weight of the amorphous silicon dioxide as the binder;
wherein the composition comprises approximately 60 to 92 percent by weight sodium chlorate as the oxygen source; and
wherein the composition comprises approximately 0.1 to 3.0 percent by weight of the feldspar and approximately 0.1 to 3.0 percent by weight of the anhydrous aluminum silicate as the additive.

25) The oxygen generating composition of claim 21 wherein the composition comprises approximately 0.1 to 10 percent by weight of feldspar.

26) The oxygen generating composition of claim 21, wherein the feldspar comprises:
approximately 68 percent by weight of silicon dioxide;
approximately 19 percent by weight of aluminum oxide;
approximately 6.5 percent by weight of sodium oxide;
approximately 4.5 percent by weight of potassium oxide; and
approximately 1.6 percent by weight of calcium oxide.

27) The oxygen generating composition of claim 21, wherein the feldspar comprises:
approximately 0 to 17 percent by weight of potassium oxide;
approximately 0 to 12 percent by weight of sodium oxide;
approximately 0 to 20 percent by weight of calcium oxide;
approximately 18 to 36 percent by weight of aluminum oxide; and
approximately 44 to 70 percent by weight of silicon dioxide.

28) The oxygen generating composition of claim 21, wherein the anhydrous aluminum silicate comprises:
approximately 50 percent by weight of silicon dioxide;
approximately 42 percent by weight of aluminum oxide; and
approximately 2.5 percent by weight of titanium dioxide.

29) The improved oxygen generating composition of claim 21, wherein the composition is capable of producing breathable oxygen gas at a flow rate of approximately 0.1 to 30 L/min.

30) The oxygen generating composition of claim 21, wherein the composition further comprises:
a pyrotechnic powder, wherein the pyrotechnic powder is in the form of a loose powder, a compacted layer on the top of the candle, a pellet pressed into the candle, or packed in a metal tube that is pressed into the candle; and
an ignition layer, wherein the ignition layer comprises a fuel and/or catalyst rich mixture, a binder, and an oxygen source.
